(19) United States
(12) Patent Application Publication
(10) Pub. No.: US 2015/0162748 A1
(43) Pub. Date: Jun. 11, 2015

(54) DISABLING THE INVERTER OF A PHOTOVOLTAIC INSTALLATION IN THE EVENT OF THEFT

(71) Applicant: Fronius International GmbH, Pettenbach (AT)

(72) Inventors: Robert Reder, Niederneukirchen (AT); Stefan Martetschlaeger, Linz (AT); Mark Koller, Niedernsill (AT); Gerald Bart, Pasching (AT); Florian Schuster, Traun (AT); Roland Lecher, Pasching (AT)

(73) Assignee: Fronius International GmbH, Pettenbach (AT)

(21) Appl. No.: 14/407,168

(22) PCT Filed: Jun. 10, 2013
(86) PCT No.: PCT/AT2013/050116

§ 371 Date: Dec. 11, 2014

(30) Foreign Application Priority Data
Jun. 12, 2012 (AT) A 676/2012

(51) Int. Cl. H02J 3/04

(52) U.S. Cl. CPC H02J 3/04

(57) ABSTRACT

A method for operating an inverter (1) of a photovoltaic installation is specified, wherein a reference value/reference profile of at least one parameter of the photovoltaic installation is compared with an actual value/actual profile of said parameter. If the deviation between said actual value/actual profile and the reference value/reference profile exceeds a predefinable threshold, then the inverter function of the inverter (1) is at least temporarily disabled. Furthermore, an inverter (1) for carrying out said method is specified.

The invention relates to a method for operating an inverter of a photovoltaic installation in which a reference value/reference profile of at least one parameter of the photovoltaic installation is compared with an actual value/actual profile of said parameter. Furthermore, the invention relates to an inverter for a photovoltaic installation comprising means for comparing a reference value/reference profile of at least one parameter of the photovoltaic installation with an actual value/actual profile of said parameter.

An inverter and/or an operating method of this kind are known in principle. For example, the latter are used to detect faults in a photovoltaic installation. For the relevant prior art reference is made to AT 508 834 A1 of the same applicant.

Unfortunately, components of a photovoltaic installation, particularly inverters of this kind, are increasingly prone to theft. This represents a financial loss for the operator both in terms of investment and in terms of the income made from the photovoltaic installation. Many potential investors are discouraged from installing a photovoltaic installation for this reason, which is a stumbling block, particularly with regard to the energy revolution aspired to in many places.

Therefore, the objective of the invention is to provide an improved inverter of a photovoltaic installation and an improved method for operating the latter. In particular, its aim is to prevent such thefts as far as possible or at least make them easier to solve.

The objective of the invention is achieved by a method of the aforementioned kind, in which the inverter function of the inverter is disabled at least temporarily if the difference between the said actual value/actual profile and the reference value/reference profile exceeds a predefinable threshold.

The objective of the invention is also achieved by an inverter of the aforementioned kind which additionally comprises means for at least temporarily disabling the inverter function of the inverter if the difference between the at least one said actual value/actual profile and the at least one reference value/reference profile exceeds a predefinable threshold.

Within the scope of the invention the term “disablement” or “disabling” means deactivating the inverter function of the inverter, which prevents the unauthorized or nonauthorized use of a technically functional inverter during normal operation or regular operation. In other words a disabled inverter could perform its inverter function but is “not allowed” to.

Within the scope of the invention the term “normal operation” or “regular operation” refers to an operating state of the inverter in which it is operated in a designated environment, for which the inverter is specified, and in particular performs its inverter function.

For example, a load shedding of the inverter, which is caused by a voltage fluctuation of a grid supplied by the inverter, is not defined as a “disablement” or “disabling” within the meaning of the invention, as said voltage fluctuations can occur at any time during normal operation.

In particular, within the scope of the invention a “disablement” or “disabling” can also be defined as a deactivation of the inverter function of the inverter, which is not automatically reversed just by removing the reason for the disablement or disabling.

Advantageously, by means of the said measures the inverter can only be operated in a reference environment and the removal of the inverter leads (e.g. by theft) leads to the disablement thereof. For a thief an inverter of this kind is worthless as it can no longer be re-enabled easily.

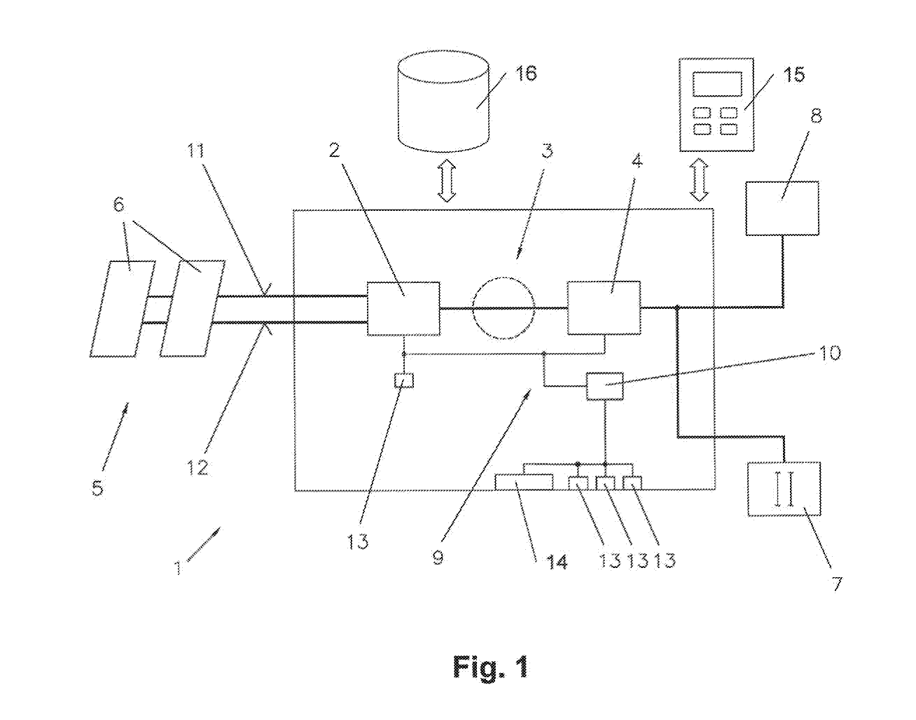

FIG. 1 Advantageous embodiments and developments of the invention are described in the subclaims and in the description in combination with the figures.

FIG. 2

It is advantageous if the inverter function of the inverter is only disabled after a predefinable time period after exceeding the set threshold. In this way it is possible to prevent the inverter function being deactivated after only short-term differences between the said actual value/actual profile and the reference value/reference profile/reference ratio.

It is an advantage if in addition to disabling the inverter function a status message is issued which relates to the theft of the inverter. In this way it is possible to indicate to an owner of the inverter that the latter has been identified as stolen. On the one hand, this can scare off the thief of the inverter and prevent him committing further crimes, as the inverter would be difficult to sell in this condition. On the other hand, this is also valuable information for a purchaser who may have acquired a stolen inverter in good faith. In a particularly advantageous variant of the invention the status message can comprise reference information saved in the inverter about the location and/or owner of the inverter. In this way stolen and recovered inverters can be matched to the rightful owner.

It is also advantageous if
the reference value/reference profile of the at least one parameter of the photovoltaic installation is determined at a first time point or during a first time period and saved,
the actual value/actual profile of the said parameter is determined at a second time point or in a second time period.

In this variant reference values determined in the past are compared with currently determined actual values and used to disable an inverter. At the same time it is possible to compare the chronological sequences of the said values with one another. Of course, a reference value/reference profile/reference ratio can be predefined or entered manually in advance.

It is also advantageous in the above case if periodically recurring time points and/or time periods are selected. In this variant of the method the reference value/reference profile and the actual value/actual profile of a parameter of the photovoltaic installation are determined at periodically recurring time points or periodically recurring time periods. In this case the time points/time periods have comparable, typical and/or characteristic terms. For example instantaneous values of the parameters recorded at the same time on different days are compared with one another for the disablement of the inverter. Likewise, periodically recurring chronological sequences of the parameters can be compared on different days but in the same time period (thus e.g. the respective profiles from 8:00 to 17:00). If the profiles of parameters differ too much from one another the inverter is disabled. In a similar manner time points or time periods recurring periodically each year can be used to compare the parameter values or parameter profiles. For example, the profile recorded on 1 July between 8:00 and 17:00 can be compared with the profile recorded on 1 July in a previous year between 8:00 and 17:00. Of course, these times are given purely by way of example and the selection of a different time point or a different time period is possible. In principle however in said selection the sunlight conditions should be within a similar range. This means for example that the output or the daily output curve should be similar. Thus 1 July can be used for example as a key date for the comparison, but the actual comparison can be performed on a day with similar sunlight conditions.

In a further preferred variant of the method the average value, difference, ratio determined in a time period or the integral determined in a time period of the at least one parameter of the photovoltaic installation is used as the reference value. In order to ignore isolated phenomena, such as for example the temporary shading of the photovoltaic module, in this variant of the method an average valve determined in a time period or integral is used for disabling the inverter.

It is advantageous if the following are used as one or more of the parameters:
an input voltage of the inverter,
a voltage of a grid supplied by the inverter,
the open circuit voltage of the photovoltaic module connected to the inverter,
the voltage of the photovoltaic module connected to the inverter at the operating point of maximum power,
the ratio between the said open circuit voltage and the said voltage at maximum power,
an input current of the inverter,
the short-circuit current of the photovoltaic module connected to the inverter,
the current of the photovoltaic module connected to the inverter at the operating point of maximum power,
an input power of the inverter,
the power of the photovoltaic module connected to the inverter at the operating point of maximum power,
radiation power,
the length of the electric cables connected to the inverter,
an inverse characteristic curve of the photovoltaic module connected to the inverter,
a module temperature,
an instantaneous value, a time profile, an integral or an average value of said voltages, said currents, said outputs, said ratio, said length, said characteristic curve or said temperature,
a switching status of a tamper contact,
the number of photovoltaic modules connected to the inverter,
the number of the strings of photovoltaic modules connected to the inverter, or
an identification factor of a component of the photovoltaic installation for detection as a reference value and as an actual value.

Furthermore, parameters can also be used such as for example:
a ratio of the input currents of a plurality of strings of the photovoltaic installation,
a ratio between the open circuit voltages (Umpp) in inverters with a plurality of trackers and their chronological profile relative to one another (in this way PV installations can be recognized very effectively particularly in unequal alignment),
a ratio between input currents in inverters with a plurality of strings and their chronological profile to one another (in this way PV systems can be recognized very effectively particularly in unequal alignment),
a ratio of the powers of a plurality of strings to one another,
a time point when the maximum power has been reached so that conclusions can be drawn from the time or day and date about the alignment and/or the roof inclination of the module.

For the method according to the invention a series of parameters of the photovoltaic installation is available which can be used for disabling the inverter. In general, an input voltage of the inverter, an input current of the inverter or an input power of the inverter can be measured. Said values are generally already available in the inverter or can be determined easily so that the invention can be implemented with only a small amount of effort. In particular, for example data from a photovoltaic module connected to the inverter can be used, such as its open circuit voltage (U₀) or its voltage at the operating point of maximum power (U_{MPP}). Likewise the ratio of said voltages can be evaluated. Advantageously, said values are generally already available so that the invention can be applied in practice with only a small amount of effort. The same also applies to the short-circuit current (I₀) of the photovoltaic module, its current at the operating point of maximum power (I_{MPP}) and its power at the operating point maximum power (P_{MPP}). Further parameters connected with a photovoltaic module include the number of photovoltaic modules connected to the inverter, the number of strings of photovoltaic modules connected to the inverter and the ratio and the profile of the individual electrical parameters (U, I, P) to one another.

A further property of the photovoltaic module connected to the inverter is its inverse characteristic curve. In this case a photovoltaic module is operated during the night as a diode and charged with a low current of several mA. By evaluating the said characteristic curve it is also possible to check whether the inverter is still connected to the “correct” photovoltaic modules or is no longer connected thereto. Further parameters which can be used for disabling an inverter are the radiation power measured by a separate sensor (for example by a sensor box), the temperature of the photovoltaic module measured by a temperature sensor and the length of the electric cables connected to the inverter, which can be measured for example by a running time measurement of a modulated pulse.

In addition the voltage of a grid supplied by the inverter can be used, as long as the photovoltaic module is not the only power source in said grid. This applies for example to public grids, which very reliably provide a very limited voltage. If this voltage can no longer be measured, there has either been a power failure or the inverter has been disconnected from the grid. In order to prevent the premature disablement of the inverter a suitable waiting time can be defined or other parameters can also be included in the check.

Furthermore, an instantaneous value, a chronological sequence, an integral, differences or an average of said voltages, said currents, said powers, said ratio, said length, said characteristic curve or said temperature can be evaluated. For example, the periodically recurring chronological sequences of the input power of the inverter can be compared on different days but over the same time period (thus e.g. in the time period from 8:00 to 17:00). If the profiles of the input power differ too significantly from one another the inverter is disabled. At the same time instantaneous values of the said input power, which were recorded at the same time on different days, are compared with one another for this purpose. In a similar manner the periodically recurring time points or time periods in each year can be used for comparing the parameter values or parameter profiles. For example the profile of said input power recorded on 1 July between 8:00 and 17:00 is compared with the profile of the said input power recorded on a 1 July in one of the preceding years between 8:00 and 17:00. Of course, the selection of the input power as a parameter and the time details are given purely by way of example, and it is also possible to select a different parameter, a different time point or another time period.

Further options for disabling an inverter are to evaluate a switching state of a tamper contact, which is triggered for example on opening the housing of the inverter or on lifting the latter from a mounting surface.

Lastly, it is also possible for an identification factor of a component of the photovoltaic installation that is in permanent or temporary connection/communication with the inverter to be used for detection as a reference value and as an actual value. Many devices have a clear identification factor in the form of a serial number or the like which is saved in a memory of the relevant device. For example, the latter can be exchanged via a data connection or a data bus and used to perform the said check. If the actual identification factor does not correspond with the reference identification, the inverter is disabled. In particular, the inverter can refer to the identification factor of a display and/or control unit connected therewith.

It is also advantageous if location information and/or owner information are used as the parameter and reference information about the location and/or owner of the inverter saved to the inverter is compared with actual information about the location and/or owner of at least one component installed in the photovoltaic installation. In this variant of the method information about the location and/or owner of the inverter is compared with information about the location and/or owner of another component of the photovoltaic installation (for example a remote display and/or control unit) and used to disable the inverter.

It is preferable if the information about the location and/or owner of the inverter is saved in the inverter itself and/or in a central database and information about the location and/or owner of the said component of the solar installation is saved in said component itself and/or is saved in a central database. The advantage of locally saved information (i.e. in the inverter itself or in the said component itself) is that the latter can still be retrieved by the inverter itself when there is no connection to a database. Preferably, in addition a secured memory is provided which cannot be manipulated by a thief of the inverter or can only be manipulated with great difficulty. The advantage of having information saved in a central database is that the latter cannot be accessed by a thief of the inverter and the latter is therefore even more difficult to manipulate.

It is particularly advantageous if
reference information is saved about the location and/or owner of the inverter,
a check is made after and/or during the disablement as to whether the reference information has been compared with information about the location and/or owner of at least one component installed in the photovoltaic installation and
information about the location and/or owner assigned to said component is emitted when the comparison has a negative result.

In this variant of the method information about the location and/or owner of the inverter is compared with information about the location and/or owner of another component of the photovoltaic installation. In addition to the already mentioned option of using this information for disabling the inverter a relevant status message can also be emitted. For example, on the display of the inverter the actual location and/or the actual owner are displayed, so that stolen and recovered inverters can be matched to the rightful owner. Furthermore, this information is also evident to a potential purchaser of the stolen inverter who would thus be deterred from making such a purchase. In a particularly advantageous variant of the invention the said information is transmitted automatically to the reference owner (i.e. the rightful owner). Of course, a plurality of addressees, e.g. rightful owner, manufacturer of the inverter, police etc. can be provided. Thus for example it is possible to use phone numbers or e-mail addresses. For the sake of completion it should be mentioned that it is not absolutely necessary to disable the inverter to provide the above information about the location and/or owner, which is based on a negative comparison of reference information about the location and/or owner of the inverter with information about the location and/or owner of another component. Of course, the disablement can also be initiated by other, already mentioned mechanisms explained in detail in the following.

It is also particularly advantageous if the inverter is connected to a specific remote display and/or control unit and the functional status of a communications connection between the inverter and the remote display and/or control unit is provided as the parameter of the photovoltaic installation. It is often the case in a photovoltaic installation that the inverter exchanges data with a remote display and/or control unit, for example via cable, optically or by radio. It is possible to take advantage of this situation and check whether a communications connection exists or not between the inverter and the remote display and/or control unit. If the latter fails (particularly over a longer time period) it can be assumed that the inverter has been stolen. The inverter is then disabled.

It is particularly advantageous in the above case if the inverter function of the inverter is deactivated once a timing element (timer) has run out, which is set to a predefinable time period, and the remote display and/or control unit periodically transmits, at shorter time intervals than the said time period, commands to reset the timing element. In this variant of the invention the remote display and/or control unit periodically sends commands to set a timer in the inverter, which timer triggers the deactivation of the inverter once it has run out. As the remote display and/or control unit with a sustained communications connection regularly sends a command to reset the timer before the latter runs out the inverter is not disabled during normal operation. However, if the communications connection fails before sending said command the timer in the inverter will run out and then the latter will be disabled.

It is advantageous if the communications connection between the inverter and the remote display and/or control unit is encrypted. In this way it is more difficult for a thief to simulate a sustained communications connection to a remote display and/or control unit for the inverter, when in fact the communications connection no longer exists.

It is also advantageous if a disabled inverter can be re-enabled by entering or transmitting a code into or to the inverter. In this way it is ensured that only an authorized user can re-start the inverter. For example, the code can be saved on an RFID tag (radio frequency identification), which if necessary is kept on a reading device on the inverter. Said RFID tag is embedded in a card for example or also attached onto or into a portable device of the photovoltaic installation. Such a portable device can be for example a mobile display or a mobile operating part. Lastly, the code for example can also be saved on NFC enabled (near field communication) mobile phones. Of course, the code can also be transmitted in other ways to the inverter, for example via Bluetooth or infrared. Lastly, the code can also be entered manually via an operating field of the inverter.

It is also advantageous if the disablement of an inverter is maintained even though the reason for the disablement has disappeared and a disabled inverter can only be re-enabled by entering or transmitting a code into or to the inverter. In principle it is possible that the inverter will automatically resume its function once the reason for the disablement no longer exists. In other words, the disablement is lifted again automatically when the inverter finds “its usual” environment again. In the present variant of the method according to the invention the inverter is only re-enabled when a corresponding code is provided. The anti-theft mechanism of the inverter is thus particularly effective.

In addition, it is advantageous if a code or a copy of the code is saved in a central database and the latter is transmitted to a requesting owner of the inverter or to the inverter if an authorization check of the requesting owner is successful. By saving the code or a copy of the code in a (secure) central database it is possible to prevent a case where the inverter is not able to be put into operation again because of a missing code. For example, the code can be delivered to the user of the inverter. If the latter loses the code, he can still obtain a copy on request from the administrator of the database (for example the purchaser or manufacturer of the inverter). For example, the latter can be transmitted via a mobile radio network to a mobile phone of the user of the inverter.

Lastly, it is advantageous if a setting is checked prior to disabling the inverter, which setting is assigned to the disablement, and the disablement is then performed only if the setting allows it. In this variant of the method the disabling of the inverter is only performed if there is a corresponding setting. The disabling function can thus be switched on and off. Preferably, an active disablement is not removed by changing the said setting.

At this point it should be noted that the variants described for the operating method of the inverter and the advantages resulting therefrom relate equally to the inverter itself and vice versa.

For a better understanding of the invention the latter is explained in more detail with reference to the following figure.

FIG. 1 is a diagrammatic overview of an inverter of a photovoltaic installation.

First of all, it should be noted that in the variously described exemplary embodiments the same parts have been given the same reference numerals and the same component names, whereby the disclosures contained throughout the entire description can be applied to the same parts with the same reference numerals and same component names. Also details relating to position used in the description, such as e.g. top, bottom, side etc. relate to the currently described and represented figure and in case of a change in position should be adjusted to the new position. Furthermore, also individual features or combinations of features from the various exemplary embodiments shown and described can represent in themselves independent or inventive solutions.

All of the details relating to value ranges in the present description are defined such that the latter include any and all part ranges, e.g. a range of 1 to 10 means that all part ranges, starting from the lower limit of 1 to the upper limit 10 are included, i.e. the whole part range beginning with a lower limit of 1 or above and ending at an upper limit of 10 or less, e.g. 1 to 1.7, or 3.2 to 8.1 or 5.5 to 10.

FIG. 1 shows the structure of a known inverter 1. As the individual components or assemblies and functions of inverters 1 are already known from the prior art, the latter are not discussed in detail in the following.

The inverter 1 comprises at least one intermediate circuit 3 and an output DC-AC converter 4, an input DC-DC converter 2 being optional. A power source 5 or power generator is connected to the input DC-DC converter 2, said power source being preferably formed by one or more parallel and/or series connected solar modules 6. The inverter 1 and the solar modules 6 are also referred to as a photovoltaic installation or PV installation. The output of the inverter 1 or the output DC-AC converter 4 can be connected to a supply grid 7, such as a public or private AC grid or a multi-phase grid and/or to at least one electric consumer unit 8, which represents a load. For example, a consumer unit 8 is in the form of a motor, refrigerator, radio device etc. Likewise the consumer unit 8 can also be a domestic power supply. The individual components of the inverter 1, such as the input DC-DC converter 2 etc., can be connected via a data bus 9 to a control device 10.

Preferably, an inverter 1 of this kind serves as a so-called grid-connected inverter 1, the power management of which is optimized to supply as much power as possible to the power grid 7. As known from the prior art, consumer units 8 are supplied via the power grid 7. Of course, a plurality of parallel connected inverters 1 can also be used. In this way more power can be provided for operating the consumer unit 8.

Said power is supplied by the power source 5 in the form of direct voltage, which is connected via two connecting lines 11, 12 to the inverter 1.

The control device 10 or the controller of the inverter 1 is formed for example by a microprocessor, microcontroller or computer. By means of the control device 10 the individual components of the inverter 1 can be controlled accordingly, such as the input DC-DC converter 2 or the output DC-AC converter 4, in particular switching elements arranged therein. In the control device 10 the individual regulation or control sequences are saved by corresponding software programs and/or data or characteristic curves.

Furthermore, operating elements 13 are connected to the control device 10, by means of which the user can configure the inverter 1 for example and/or display and adjust operating states. The operating elements are connected for example via the data bus 9 or directly to the control device 10. Such operating elements 13 are arranged for example on a front of the inverter 1 so that operation is possible from the outside. Likewise the operating elements 13 can also be arranged directly on assemblies and/or modules inside the inverter 1. Lastly, the inverter 1 comprises an output device 14 connected to the control device 10 and controlled by the latter (e.g. light-emitting diodes, a display and/or loudspeaker).

The inverter 1 in the shown example is in communication connection with an optional external display and/or control unit 15 and with an optional external database 16. The communications connection can be radio or wire-based respectively.

In the shown arrangement, in particular in the inverter 1 itself, a method is performed in which a reference value/reference profile of at least one parameter of the photovoltaic installation is compared with an actual value/actual profile of the said parameter, and the inverter function of the inverter 1 is disabled at least temporarily when the difference between the said actual value/actual profile and the reference value/reference profile exceeds a predefinable threshold.

The inverter 1 thus comprises means for comparing a reference value/reference profile of at least one parameter of the photovoltaic installation with an actual value/actual profile of the said parameter and means for at least temporarily disabling the inverter function of the inverter, when the difference between the said actual value/actual profile and the reference value/reference profile exceeds a predefinable threshold. The said means can be formed for example by part of the software of the control device 10.

In this variant reference values/reference profiles determined in the past are compared with currently determined actual values/actual profiles and are used for disabling an inverter 1. In particular, to determine the measurement value periodically recurring time points and/or time periods are selected. For example, the measurement values are determined at the same time on different days or at the same time on the same days in different years. Accordingly, the determined actual values/actual profiles can be used after comparison for the subsequent comparison as reference values/reference profiles. For example, for this purpose it is possible to use instantaneous values or profiles of an input voltage of the inverter 1, a voltage of the grid 7 supplied by the inverter 1, the open circuit voltage of the photovoltaic module 6 (U₀) connected to the inverter 1, the voltage of the photovoltaic module 6 connected to the inverter 1 at the operating point of maximum power (U_{MPP}), the ratio of said voltages U₀ and U_{MPP}, an input current of the inverter 1, the short-circuit current of the photovoltaic module 6 (I₀), its current at the operating point maximum power (I_{MPP}), an input power of the inverter 1, the power of the photovoltaic module 6 at the operating point of maximum power (P_{MPP}), radiation power (for example measured by a separate sensor which is arranged in the region of the photovoltaic module 6 and determines the power radiated by the sun), the number of photovoltaic modules 6 connected to the inverter 1, the number of strings of photovoltaic modules 6 connected to the inverter 1, the length of the electric cables 11, 12 connected to the inverter 6, an inverse characteristic curve of the photovoltaic module 6 connected to the inverter 1 and/or a temperature of the photovoltaic module 6 (for example measured by a separate temperature sensor which is arranged in the region of the photovoltaic module 6 and determines its temperature).

Instead of instantaneous values of the said parameters a time profile, an integral or an average value of the said parameters can be evaluated.

A further way of disabling an inverter 1 is to evaluate a switching state of a tamper contact, triggered for example on opening the housing of the inverter 1 or on lifting the latter from an assembly surface.

Lastly, an identification factor of a component 6, 13 of the photovoltaic installation can be used for detecting a reference value and an actual value. In this example it is assumed that the display and/or control unit 15 has such an identification factor, e.g. in the form of a serial number or the like. The latter is saved for example in a memory of the display/control unit 15. By means of the communications connection the actual identification factor can be transmitted to the inverter 1 and compared in the control device 10 with a reference identification saved therein. If the actual identification factor does not coincide with the reference identification the inverter 1 is disabled or deactivated. Of course, the identification factors of other system parts can be used for the comparison, for example identification factors of the photovoltaic module 6, as long as the latter is set up for this.

In addition or alternatively to the option described above the functional status of the communications connection between the inverter 1 and the remote display/control unit 15 can be used for the disablement of the inverter 1. If the communications connection fails (particularly over a longer time period) it can be assumed that the inverter has been stolen. The inverter is then disabled.

Preferably, the inverter function of the inverter 1 is generally deactivated after a timing element has run out, said timer being set to a predefinable time period so that short breaks in the communications connection or only brief differences between an actual value/actual profile and a reference value/reference profile are ignored.

In a particularly advantageous variant of the method the remote display/control unit 15 periodically transmits, at shorter time intervals than the said time period, commands to reset the timing element. As the remote display and/or control unit 15 with a maintained communications connection regularly sends a command to reset the timer before the expiry of the latter, the inverter is not disabled during regular operation. However, if the communications connection fails before said command is sent the timer will run out in the inverter 1 and the latter will be disabled. Thus the inverter 1 is continually updated via the communications connection as to which components of the PV system have which status. Accordingly, this applies not only to the display and/or control unit 15 but to all of the components of the PV installation, such as the data logger, string control, sensor box, gateway, router and/or power manager.

Preferably, said communications connection is encrypted in order to make it difficult or impossible for a thief to simulate a sustained communications connection to the display/control unit 15, when in fact a communications connection no longer exists. The method is particularly effective if the display/control unit 15 is arranged in a secured environment from which it cannot be stolen or only with considerable effort. For example, it can be arranged in a disabled and well secured house, whereas the inverter 1 may possibly only be housed in a shed that is easy to break into, in easily accessible open areas, assembly frames, trackers (tracking systems), car parks or the like.

In general, the inverter 1 can automatically resume its function once the reason for the disablement has been removed. This means specifically that when the disablement is maintained a match is identified between the actual value/actual profile and a reference value/reference profile or actual identification factor and reference identification and/or an intact communications connection to the display/control unit 15.

In an advantageous variant a disabled inverter 1 can only be re-enabled by entering or transmitting a code into or to the inverter. In this way it is ensured that only an authorized user can put the inverter 1 back into operation. For example, the code can be saved on an RFID tag (radio frequency identification), which if necessary is kept on a reading device on the inverter 1. Said RFID tag is embedded for example in a card or also attached onto or into a portable device of the photovoltaic installation, for example on the display/control unit 15. The code can however also be transmitted via the communications connection between the display/control unit 15 and inverter 1. The code can also be entered manually via the operating keys 13 of the inverter 1 or on the operating field of the display/control unit 15. It would also be possible to transmit the code from a mobile phone to the inverter 1 directly or via the display/control unit 15.

It is also advantageous if the code is sent from the database 16 to the inverter 1, the display/control unit 15 or a mobile phone, when the user of the photovoltaic installation is not or is no longer in possession of the code. In addition, the code or a copy of the code is saved in the central database 16 and transmitted after the successful authorization check of the enquiring, owner. By saving the code or a copy of the code in a (secure) central database it is possible to avoid the possibility that the inverter can no longer be operated because of a missing code.

In general it is possible that a setting assigned to the disablement is checked before disabling the inverter and disablement is only performed when the setting allows this. In this variant of the method the inverter is only disabled in the presence of a suitable setting. The disabling function can thus be switched on and off, for example by the operating keys 13 of the inverter 1 or on the operating field of the display/control unit 15. Preferably, an active disablement is not removed by changing said setting.

It is also advantageous if in addition to deactivating the inverter function a status message is emitted which relates to the theft of the inverter 1. For example, said status message can be emitted on the output device 14 of the inverter 1 and/or on a display of the display/control unit 15 and/or transmitted to the database 16 or further stations, such as for example to a mobile phone of the owner of the inverter 1 or to the police. In particular, if said message is emitted directly on the output device 14 of the inverter 1, the inverter is virtually impossible to sell, as a potential purchaser will immediately be made aware that it is stolen. In a further preferred variant a message is sent from the inverter 1 to the display/control unit 15 and only forwarded from there to other places, such as for example to the database 16. In this way a thief is prevented from accessing the relevant message.

In a particularly advantageous variant of the method the status message can comprise reference information saved in the inverter 1 about the location and/or owner of the inverter 1 on the output device 14. In this way stolen and recovered inverters 1 can be easily matched to the rightful owner.

In general location information and/or owner information can be used as parameters and reference information about the location and/or owner of the inverters 1 saved to the inverter 1 can be compared with current information about the location and/or owner of at least one component installed in the photovoltaic installation, for example the display/control unit 15. This variant is very similar to the variant already explained in which an identification factor of a component installed in the photovoltaic installation is used for deactivating the inverter. However, in this variant the location or owner information is in place of the identification factor. In contrast to the previously explained variant the inverter 1 does not need to receive any information about the display/control unit 15, i.e. its identification factor. It is sufficient if there is a match between the information saved in the inverter 1 about the location and/or owner and the information about location and/or owner saved in the display/control unit 15. A further clear difference is also that each identification factor in the photovoltaic installation only occurs once, a component is thus clearly identified, whereas the information about the location and/or owner can (should) be the same in all components. Of course, location or owner information can also be evaluated in combination with identification factors.

Information about the location and/or owner of the inverter 1 can be saved in the inverter 1 itself and/or in the central database 16. Likewise, information about the location and/or owner of the display/control unit 15 can be saved in the display/control unit 15 itself and/or in the central database 16. The advantage of locally saved information is that the latter is then available inside the photovoltaic installation, if there is no connection to the database 16. The advantage of having information saved in the central database 16 is that the latter is generally inaccessible to a thief.

In a further advantageous variant of the method reference information about the location and/or owner of the inverter 1 is saved and after and/or during a disablement a check is performed to see whether the reference information compares with information about the location and/or owner of at least one component installed in the photovoltaic installation (for example the display/control unit 15 again). If the comparison has a negative result the information about location and/or owner assigned to the display/control unit 15 is emitted. In this way it is possible to discover the new location of the inverter 1 if the latter has been stolen and put into operation in another photovoltaic installation. In this way it possible with comparatively little effort to secure the inverter 1 and return it to the rightful owner. Information about the location and/or owner is preferably transmitted to the database 16, to a device of the rightful owner and/or to the police.

In a further advantageous variant of the method a warning can be emitted after a difference has been recognized between an actual value/actual profile and a reference value/reference profile but before the inverter 1 is disabled. In this way the user of the inverter 1 can be made aware of the risk of disablement and undertake suitable counter measures to prevent unnecessary disablement. For example, a faulty communications connection between the inverter 1 and the display/control unit 15, the functional status of which is checked for the disablement of the inverter 1, could be out of action longer than expected without the inverter 1 having been stolen.

In a particularly advantageous embodiment the inverter 1 can assume the following states with regard to the proposed method:
not secured (no protective function activated)
secured/regular operation (protective function is activated and the inverter 1 is in a state of authorized, normal operation)
secured/warning/regular operation (the protective function is activated and the inverter 1 is in a state of authorized, normal operation. However, a difference has been recognized between an actual value/actual profile and a reference value/reference profile. An assigned timer is still active however)
secured/disabled (the protective function is activated and the inverter 1 is disabled because a difference has been recognized between an actual value/actual profile and a reference value/reference profile and in addition an assigned timer has run out.

Of course, a message can also be sent about a non-secured or secured state. For example, an active protective function can be displayed by a flashing light-emitting diode on the inverter 1.

In another variant of the method it is also possible that an environment of the inverter can be re-read, this means that new reference values/reference profiles are determined, for example if an authorized changed has been made in the photovoltaic installation. Preferably, the input of a code is necessary to prevent the unauthorized detection of the reference values/reference profiles.

In general, it should be noted that the proposed method need not necessarily run in the inverter 1, although this has some advantages. It would also be possible for the whole proposed method or only parts thereof to be performed in another component of the photovoltaic installation or even in a remote superordinate control device. For example, the comparison of a reference-value/reference-profile with an actual value/actual profile could be performed in a control device locally adjacent to the database 16. From there corresponding commands can also be sent to the components of the photovoltaic installation or messages received from the latter. For example, the command to disable the inverter 1 could be issued from there.

It is thus particularly advantageous if the monitoring of the functional status of the communications connection between the inverter 1 and the remote display/control unit 15 for the disablement of the inverter 1 (also) is performed in the display/control unit 15. In this case it is practically impossible for a thief to interfere with the transmission of a corresponding status message. For example, the inverter 1 could (also) periodically send out commands to set a timer located in the display/control unit 15. However, if the communications connection fails prior to sending out said command the timer in the display/control unit 15 will run out, after which the latter can emit/send out corresponding messages. Preferably, the mentioned check is performed both in the inverter 1 and in the display/control unit 15, so that both the inverter 1 and the display/control unit 15 can be set independently and without communications connection between the two measures.

As has been shown, by means of the proposed method the inverter 1 can only be operated in a reference environment and the removal of the inverter results in its disablement. In principle, several checks are needed before a disablement is performed. This means that the inverter 1 is only disabled if for example three out of five checks were false. In this way it is possible to prevent its disablement in the case of a planned stoppage of the component—for example during a service. Likewise communications connections can also be interrupted which would cause the result of the check to be incorrect. Thus intentionally incorrect results of checks are taken into consideration so that the inverter 1 can continue to operate. For a thief such an inverter 1 is worthless as it can no longer be easily re-enabled.

The exemplary embodiments show possible embodiment variants of a photovoltaic installation or an inverter 1 according to the invention, whereby it should be noted at this point that the invention is not restricted to the embodiment variants shown in particular, but rather various different combinations of the individual embodiment variants are also possible and this variability, due to the teaching on technical procedure, lies within the ability of a person skilled in the art in this technical field. Thus all conceivable embodiment variants, which are made possible by combining individual details of the embodiment variants shown and described, are also covered by the scope of protection

In particular, it should be noted that in reality a photovoltaic installation or an inverter 1 can also comprise more or fewer components than shown in the drawings.

Finally, as a point of formality, it should be noted that for a better understanding of the structure of the photovoltaic installation and the inverter 1, the latter and its components have not been represented true to scale in part and/or have been enlarged and/or reduced in size.

The underlying problem addressed by the independent solutions according to the invention can be taken from the description.

### LIST OF REFERENCE NUMERALS

1 inverter
2 input DC-DC
3 intermediate circuit
4 output DC-DC
5 power source
6 photovoltaic module
7 grid
8 consumer unit
9 data bus
10 control device
11 connecting line
12 connecting line
13 operating element
14 output device
15 display/control unit
16 database

1. A method for operating an inverter (1) of a photovoltaic installation, in which a reference value/reference profile of at least one parameter of the photovoltaic installation is compared with an actual value/actual profile of the said parameter,
wherein
the inverter function of the inverter (1) is disabled at least temporarily when the difference between the at least one said actual value/actual profile and the at least one reference value/reference profile exceeds a predefinable threshold and
a disabled inverter (1) is re-enabled by entering or transmitting a code into or to the inverter (1).

2. The method as claimed in claim 1, wherein the inverter function of the inverter (1) is only disabled after a predefinable time period after exceeding said threshold.

3. The method as claimed in claim 1, wherein in addition to disabling the inverter function a status message is emitted which relates to the theft of the inverter (1).

4. The method as claimed in claim 1, wherein
the reference value/reference profile of the at least one parameter of the photovoltaic installation is detected at a first time point or during a first time period and saved,
the actual value/actual profile of the said parameter is detected at a second time point or in a second time period.

5. The method as claimed in claim 4, wherein periodically recurring time points and/or time periods are selected.

6. The method as claimed in claim 4, wherein the average value, difference, ratio determined in a time period or the integral determined in a time period of the at least one parameter of the photovoltaic installation is used as a reference value.

7. The method as claimed in claim 1, wherein the following are used as one or more of the parameters:
an input voltage of the inverter (1),
a voltage of a grid (7) supplied by the inverter,
the open circuit voltage of the photovoltaic module (6) connected to the inverter (1),
the voltage of the photovoltaic module (6) connected to the inverter (1) at the operating point of maximum power,
the ratio between the said open circuit voltage and the said voltage at maximum power,
an input current of the inverter (1),
the short-circuit current of the photovoltaic module (6) connected to the inverter (1),
the current of the photovoltaic module (6) connected to the inverter (1) at the operating point of maximum power,
an input power of the inverter (1),
the power of the photovoltaic module (6) connected to the inverter (1) at the operating point of maximum power,
the radiation power,
the length of the electric cables (11, 12) connected to the inverter (1),
an inverse characteristic curve of the photovoltaic module (6) connected to the inverter (1),
a module temperature,
an instantaneous value, a time profile, an integral or an average value of said voltages, said currents, said outputs, said ratio, said length, said characteristic curve or said temperature,
a switching status of a tamper contact,
the number of the photovoltaic modules (6) connected to the inverter (1),
the number of strings of photovoltaic modules (6) connected to the inverter (1), or
identification factor of a component (6, 15) of the photovoltaic installation (1) for detection as a reference value and as an actual value.

8. The method as claimed in claim 1, wherein location information and/or owner information is used as the parameter and reference information saved to the inverter (1) about the location and/or owner of the inverter is compared with actual information about the location and/or owner of at least one component (6, 15) installed in the photovoltaic installation.

9. The method as claimed in claim 8, wherein the information about location and/or owner of the inverter (1) is saved in the inverter (1) itself and/or in a central database (16) and information about the location and/or owner of the said component (6, 15) of the photovoltaic installation are saved in said component (6, 15) itself and/or in a central database (16).

10. The method as claimed in claim 1, wherein
reference information about the location and/or owner of the inverter (1) is saved,
after and/or during disablement a check is performed to see whether the reference information has been compared with information about the location and/or owner of at least one component (6, 15) installed in the photovoltaic installation and
information about the location and/or owner related to said component (6, 15) is output if the comparison has a negative result.

11. The method as claimed in claim 1, wherein the inverter (1) is connected to a specific remote display and/or control unit (15) and the functional status of a communications connection between the inverter (1) and the remote display and/or control unit (15) is provided as the parameter of the photovoltaic installation.

12. The method as claimed in claim 11, wherein the inverter function of the inverter (1) is deactivated after the expiry of a timer, which is set to a predefinable time period, and the remote display and/or control unit (15) periodically transmits, at shorter time intervals than the said time period, commands for resetting the timer.

13. The method as claimed in claim 11, wherein the said communications connection is encrypted.

14. (canceled)

15. The method as claimed in claim 1, wherein the disablement of the inverter (1) is maintained even if the reason for the disablement has disappeared and a disabled inverter (1) can only be re-enabled by entering or transmitting a code into or to the inverter (1).

16. The method as claimed in claim 1, wherein a code or a copy of the code is saved in a central database and the latter is transmitted to an enquiring owner of the inverter (1) or to the inverter (1) if an authorization check of the enquiring owner is successful.

17. The method as claimed in claim 1, wherein prior to disabling the inverter (1) a setting is checked which is allocated to the disablement and the disabling is only performed when the setting allows it.

18. An inverter (1) for a photovoltaic installation, comprising:
means for comparing a reference value/reference profile of at least one parameter of the photovoltaic installation with an actual value/actual profile of said parameter,
wherein
it comprises means for at least temporarily disabling the inverter function of the inverter, if the difference between the said actual value/actual profile and the reference value/reference profile exceeds a predefinable threshold, and means for removing the disablement by entering or transmitting a code into or to the inverter (1).

19. The inverter (1) as claimed in claim 18, wherein it comprises means (14) for emitting a status message which relates to the theft of the inverter (1).
